(19) United States
(12) Patent Application Publication
(10) Pub. No.: US 2011/0022528 A1
(43) Pub. Date: Jan. 27, 2011

(54) Method and system for transmitting information via a plurality of different formats

(76) Inventor: Michael Hennessy, Stow, MA (US)

Correspondence Address: Michael Hennessy, 30 Pompositticutt St., Stow, MA, 01775, US

(21) Appl. No.: 12/460,901

(22) Filed: Jul. 24, 2009

(51) Int. Cl. G06Q 10/00; G06Q 99/00; G06F 15/16

(52) U.S. Cl. 705/319; 705/321; 709/246; 709/206

(57) ABSTRACT

A method for transmitting a plurality of related data items by a plurality of different formats includes assigning a unique identifier to a plurality of related data items stored on web server. The method further includes a transmitter receiving the unique identifier from a browser function and retrieving the plurality of related data items from the web server storing the unique identifier and the plurality of related data items. The transmitter formats the plurality of related data items into at least one of the different transmission formats and transmits the plurality of related data items by the formats selected by the user. In one embodiment, the browser function is a bookmarklet having the function of sending the unique identifier to the transmitter. In another embodiment, the plurality of related data items is information related to a job opportunity and the unique identifier is a job identifier. In one such embodiment, the plurality of different transmission methods includes job boards, email campaigns, key word advertising campaigns and social networking sites.

### CROSS-REFERENCE TO RELATED APPLICATIONS

Not applicable.

### STATEMENT REGARDING FEDERALLY SPONSORED RESEARCH OR DEVELOPMENT

Not applicable.

REFERENCE TO A SEQUENCE LISTING, A TABLE, OR COMPUTER PROGRAM LISTING COMPACT DISC APPENDIX

Not applicable.

### BACKGROUND OF THE INVENTION

The invention relates generally to a method and system for transmitting information and more specifically to a method and system for transmitting a plurality of related data items via a plurality of different formats.

The Internet or World Wide Web provides many mechanisms for distributing information. Individuals and companies maintain websites to distribute information. These websites may be accessed by any user or by a limited set of users. Email campaigns can be used to send information directly to a selected set of recipients. Users can post information to message boards such as the Craigslist® and Monster® boards. Social networking sites such as the Facebook®, LinkedIn® and MySpace® sites allow users to post information about themselves and to communicate with other users of the social networking site. Advertisements can be placed on websites. Upon payment of a fee, many search engines will display a predetermined set of information, such as an advertisement, upon a user's search for a particular keyword.

Each of these mechanisms has a different format for providing information. A user desiring to transmit information by several of these mechanisms will need to manually format their information for each mechanism and enter the information. For example, a user desiring to post information on the Facebook, LinkedIn and MySpace sites must access the website for each of these social networking sites and enter the information in the particular format required by each site. These sites may have different fields for information and may order the information differently. Also, only some of the mechanisms for distributing information over the Internet allow the user to track the number of times that their information is viewed. However, the mechanisms that do provide tracking, have tracking that is specific to that mechanism. There is no centralized method for tracking the number of views on all of the mechanisms through which the information is made available.

One application for the many methods of distributing information made available by the Internet is posting job opportunities. Many companies and recruiters have applicant tracking systems that are capable of tracking the status of an applicant for a job once the applicant has applied for the job, by for example, submitting a resume. In order for a company or recruiter to make use of the many methods of distributing information made available by the Internet, each of the methods must be manually addressed. Further, the user must enter the job opportunity information into each of the particular websites, such as the Monster, CareerBuilder®, and Yahoo!Hotjobs® sites, separately. In addition, there is no centralized method for tracking the number of views of each job opportunity on every mechanisms through which the job opportunity information is made available. Nor is there a centralized method for tracking the number of times applicants actually apply for a job through each method.

### BRIEF SUMMARY OF THE INVENTION

The invention relates to a method for transmitting a plurality of related data items by a plurality of different formats. The plurality of related data items may be any set of information. For example, the related data items may describe a job opportunity and include data such as company, title, description, salary, etc. The data items may also be an advertisement for goods or services, a news article, an announcement, or any other type of information. The plurality of related data items is stored on a web server. The method includes assigning a unique identifier to the plurality of related data items. The method further includes a transmitter receiving the unique identifier from a browser function executing on a client computer and retrieving the plurality of related data items from the web server storing the unique identifier and the plurality of related data items. The transmitter formats the plurality of related data items into at least one of the different formats and transmits the plurality of related data items by the format. In one embodiment, the browser function is a bookmarklet having the function of transmitting the unique identifier to the transmitter. In another embodiment, the plurality of related data items is job information and the unique identifier is a job identifier. In one such embodiment, the plurality of different transmission formats includes job boards, email campaigns, key word advertising campaigns and social networking sites.

The invention also relates to a system for transmitting a plurality of related data items by a plurality of different formats. The plurality of data items is stored on a web server and is assigned a unique identifier. The system includes a client computer with a browser, a receiver for receiving the unique identifier from a browser function, a processor in communication with the receiver; and a transmitter in communication with the processor. The processor is adapted for retrieving the plurality of related data items from the web server containing the unique identifier and formatting the plurality of related data items into at least one of the different formats. The transmitter is adapted for transmitting the plurality of related data items by the different formats. In one embodiment, the browser function is a bookmarklet. In another embodiment, the plurality of related data items is job information and the unique identifier is a job identifier. In one such embodiment, the plurality of different transmission formats includes job boards, email campaigns, key word advertising campaigns and social networking sites.

One object of the present invention is to allow a user to transmit information by a plurality of different formats without having to manually address each different format or visit multiple sites. Another object of the invention is to allow a user to centrally track the performance of all of the different formats.

### BRIEF DESCRIPTION OF THE DRAWINGS

The invention is pointed out with particularity in the appended claims. The above and further advantages of this invention may be better understood by referring to the following description taken in conjunction with the accompanying drawings, in which:

FIG. 1 is a block diagram of an embodiment of a system for transmitting a plurality of related data items via a plurality of different formats;

FIG. 2 is a flowchart representation of an embodiment of a process for transmitting a plurality of related data items via a plurality of different formats;

FIG. 3 is a pictorial view of a screenshot of an embodiment of the invention showing a list of job opportunities and associated unique job identifiers;

FIG. 4 is a pictorial view of a screenshot of an embodiment of the invention showing a populated template returned to the client computer and displayed to the user;

FIG. 5 is a pictorial view of a screenshot of an embodiment of the invention showing an example of a job opportunity displayed on the website of the company advertising the job;

FIG. 6 is a flowchart representation of an embodiment of a process for transmitting a plurality job-related data items via a plurality of different formats;

FIG. 7 is a pictorial view of a screenshot of an embodiment of the invention showing the status of all job postings with real-time statistics;

FIG. 8 is a pictorial view of a screenshot of an embodiment of the invention showing the button a user may select to remove all postings with a single click; and

FIG. 9 is a pictorial view of a screenshot of an embodiment of the invention showing the different options available to upload the browser functions to the browser running on the client computer.

Like reference characters in the respective drawn figures indicate corresponding parts.

### DETAILED DESCRIPTION OF THE INVENTION

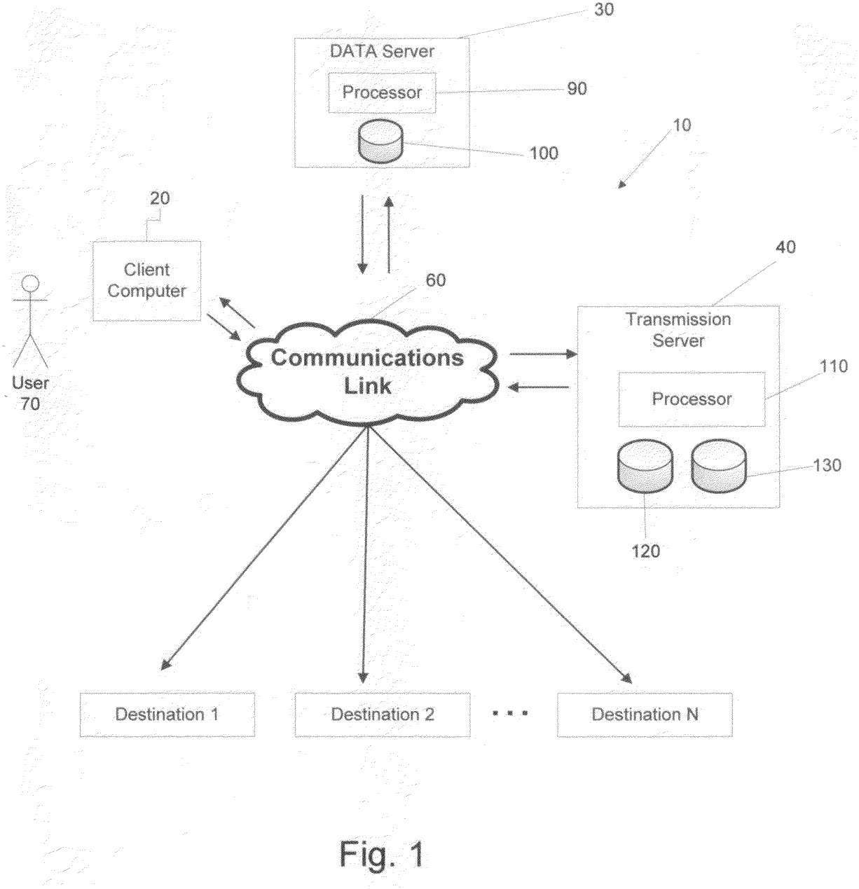

Referring to FIG. 1 and in brief overview, an embodiment of a system 10 constructed in accordance with the invention includes a client computer 20, a data server 30, a transmission server 40 and a plurality of destinations 50. In the embodiment shown, the client computer 20, data server 30, transmission server 40 and destinations 50 are connected via a communications link 60. In one embodiment, the communications link 60 is a global communications network (i.e. Internet or World Wide Web). In other embodiments, the communications link 60 may be any system by which the client computer 20, data server 30, transmission server 40 and destinations 50 may communicate. For example, the client computer 20, data server 30 and transmission server 40 may be connected via an intranet. In another embodiment, the client computer 20 and the data server 30 are the same computer. In yet another embodiment, the client computer 20, data server 30 and transmission server 40 are all the same computer.

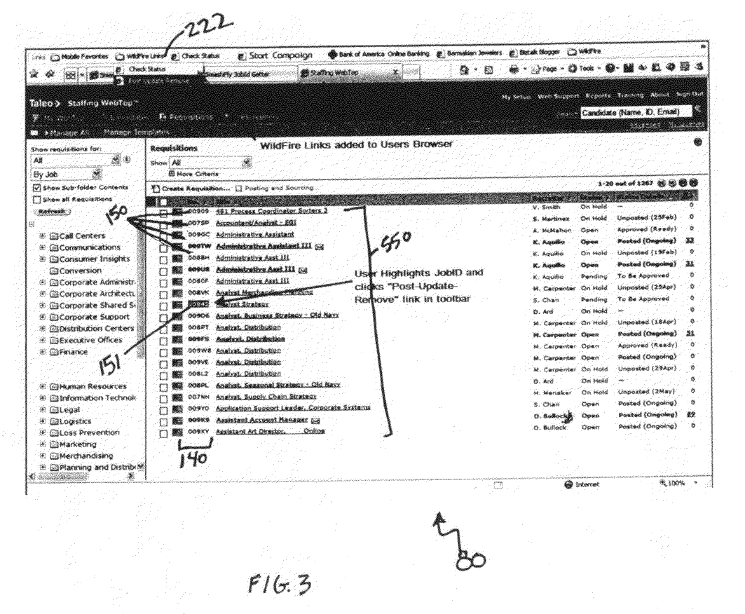

The client computer 20 is capable of executing a web browser. In other embodiments, the client computer 20 may also be capable of executing other applications, such as word processing, spreadsheet and email applications. The user 70 uses the web browser on the client computer 20 to access a web page stored on the data server 30. FIG. 3 illustrates and example of a web page 80 stored by the data server 30. The web page 80 includes a list 140 of unique identifiers 150. The example in FIG. 3 is a screenshot from the Taleo® talent management system. The web page 80 may be any web page that contains a list of unique identifiers. The list 140 of unique identifiers 150 in FIG. 3 are job identifiers assigned to different job opportunities.

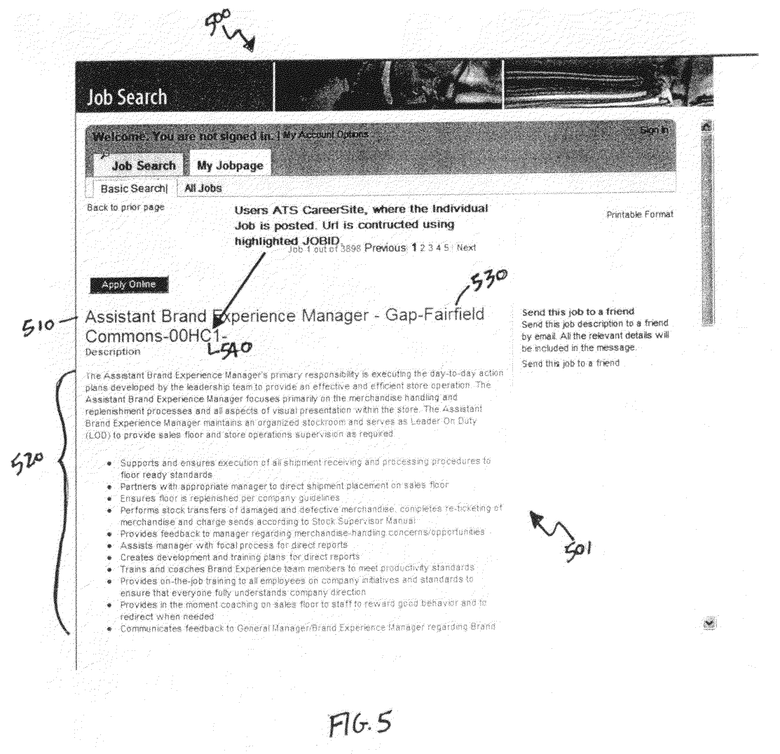

In one embodiment, the data server 30 comprises a processor 90 and a database 100. The data server 30 stores the information that the user 70 may select to transmit. In one embodiment, the information stored by the database 100 is divided into sets of related data items. Each set of related data items is assigned a unique identifier. The user 70 selects the unique identifier 150 in order to access the corresponding set of related data items. FIG. 5 shows an example of a set of related data items 501 corresponding to the unique identifier 151. The related data items 501 in FIG. 5 include job specific data such as job title 510, job description 520, location 530, city, state, etc.

In the embodiment shown in FIG. 1, the transmission server 40 comprises a processor 110, a web page database 120 and a format database 130. The web page database 120 stores a list of web pages and the data structure for the configuration of how each of the respective web pages store data. In one embodiment, the data configuration of the web pages for each user desiring to transmit information using the method of the present invention is stored in the web page database 120 prior to the user 70 making use of the method of the present invention. The format database 130 stores a list of destinations 50 and the format by which information needs to be sent to such destinations 50. In another embodiment, the format database 130 stores a list of methods by which information may be sent and the respective data formats for each method of transmission. In one embodiment, the destinations 50 are online communities, social networking sites or message boards. In yet another embodiment, the destinations 50 are websites which post advertisements. In still another embodiment, the destinations 50 are email addresses. In another embodiment, the method of transmission is a keyword campaign by which the related data items are displayed to a user upon a user performing a keyword search through, for example, a search engine.

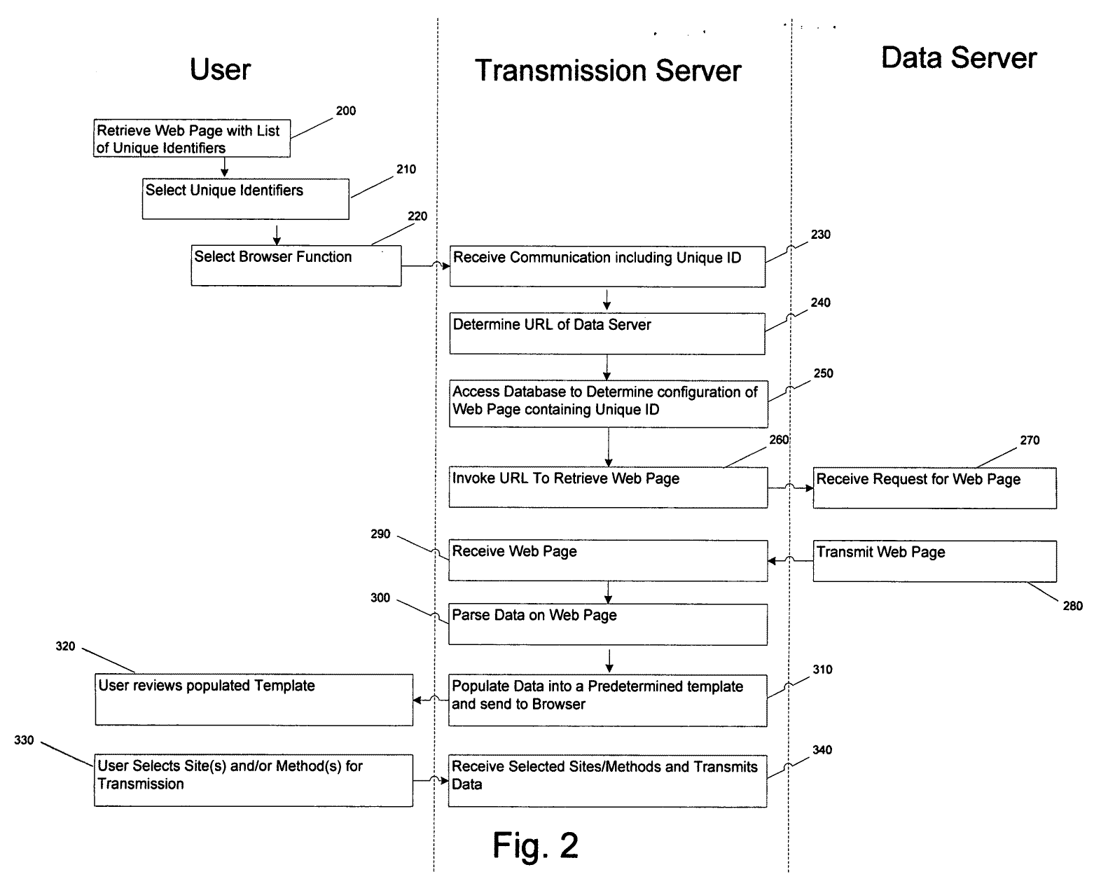

The operation of the system 10 is described with reference to FIG. 2. In step 200, the user 70 uses the web browser on the client computer 20 to access the information stored on the data server 30. As described above, in one embodiment, the information stored by the data server 30 is divided into sets of related data items, each set being assigned a unique identifier. The data server 30 retrieves the web page requested by the user 70 and display the page to the user 70 on the client computer 20. FIG. 3 shows and example of a web page 80 that may be displayed to a user 70. In the example of FIG. 3, the web page 80 displays a list of job opportunities as displayed by the Taleo talent management system. Any talent management system may be used. The web page 80 includes a list 140 of unique identifiers 150 that the user may select.

Next, in step 210, the user 70 selects a specific unique identifier 151. The user 70 may select the unique identifier 151 by selecting a check box, by clicking on the unique identifier 151, by highlighting the unique identifier 151, or by any other means know to select text or icons.

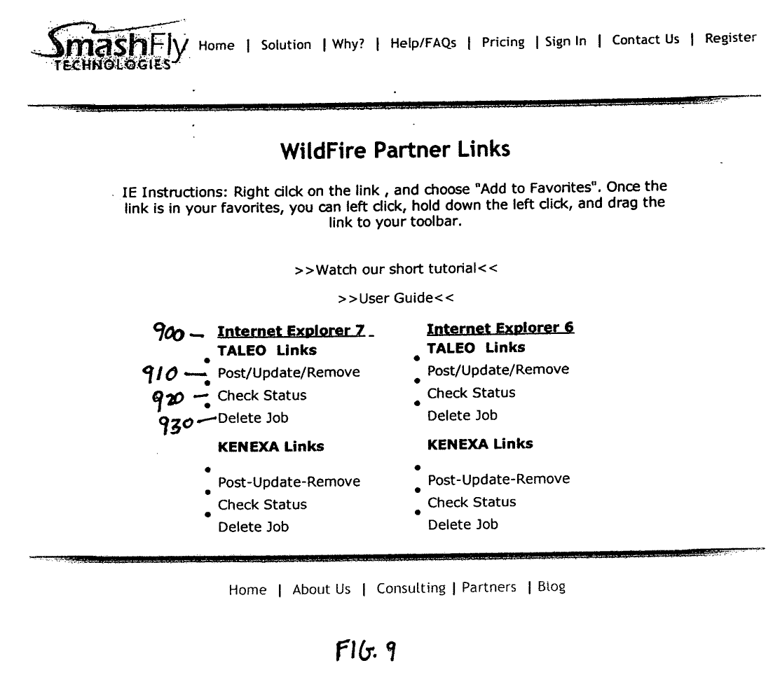

Once the unique identifier 151 is selected from the list 140, in step 220, the user 70 selects the browser function 222 that is adapted to transmit the unique identifier 151. In one embodiment, the browser function 222 is an applet stored as a URL of a bookmark in the browser and the browser function 222 is invoked by selecting the applet. In one such embodiment, the applet is a bookmarklet. In another embodiment, the browser function 222 is stored as a hyperlink on a webpage and the browser function 222 is selected by clicking on the appropriate link. In yet another embodiment, the browser function 222 is an option on a menu and is selected by choosing the option. A method for importing the browser function 222 to the browser running on the client computer 20 is described below in the discussion of FIG. 9.

The browser function 222 transmits the unique identifier 151 to the transmission server 40. In one embodiment, the unique identifier 151 is sent as one parameter of a larger message. In one such embodiment, another parameter sent is the URL of the web server 30 containing the unique identifier 151. In yet another such embodiment, another parameter sent is the URL of the specific web page 80 containing the unique identifier 151. The message may be sent as clear text, or may be coded or encrypted.

Next, in step 230, the transmission server 40 receives the communication from the browser function 222 which includes the unique identifier 151. In step 240, the transmission server 40 determines the URL of the web page containing the unique identifier 151 from the communication received in step 230. In one embodiment, the transmission server 40 uses the unique identifier 150 to determine the URL. In another embodiment, the URL is included in the message from the browser function 222. In step 250, the transmission server 40 accesses the web page database 120 and looks up the URL to determine the format or configuration of the web page containing the unique identifier 151.

In one embodiment, the user 70 who selects the browser function 222 has previously enrolled with the transmission server 40. Upon enrolling, each user 70 is assigned a unique username/password which allows the transmission server 40 to identify the user 70. In one such embodiment, when the user 70 logs in to the system 10 for the first time, the user 70 may select the “Remember me on this computer” option which then stores a permanent cookie on the client computer 20. When the user 70 next selects the browser function in step 220, invoking the function that passes the unique identifier 150 to the transmission server 40, the transmission server 40 uses the cookie to determine who the user is, and therefore which web configuration link/formatting to use.

The format of the web page informs the transmission server 40 where different data items are stored on the web page. FIG. 5 shows and example of a web page 500 that contains a unique identifier 540 selected by the user 70. The format of the web page 500 informs the transmission server 40 where to locate the different job-related data items, such as company, title, salary, etc.

Next, in step 260, the transmission server 40 invokes the URL to retrieve the web page. The data server 30 receives the request for the web page in step 270 and transmits the web page to the transmission server 40 in step 280. The transmission server 40 receives the web page in step 290 and parses the data on the web page to obtain the related data items in step 300 using the predetermined format of the web page. In one embodiment, the transmission server 40 parses HTML information to obtain the related data items. In another embodiment, the transmission server 40 retrieves the web page prior to determining the format of the data on the web page. In yet another embodiment, the transmission server 40 does not store the format of the web pages, but rather uses known techniques to parse the data on the web page.

In another embodiment of the system 10, rather than requesting and receiving a web page in steps 260, 270 280 and 290 and parsing data on the web page in step 300, the transmission server 40 invokes a “Web service” API, which then allows the transmission server 40 to programmatically retrieve the job information from the data server 30.

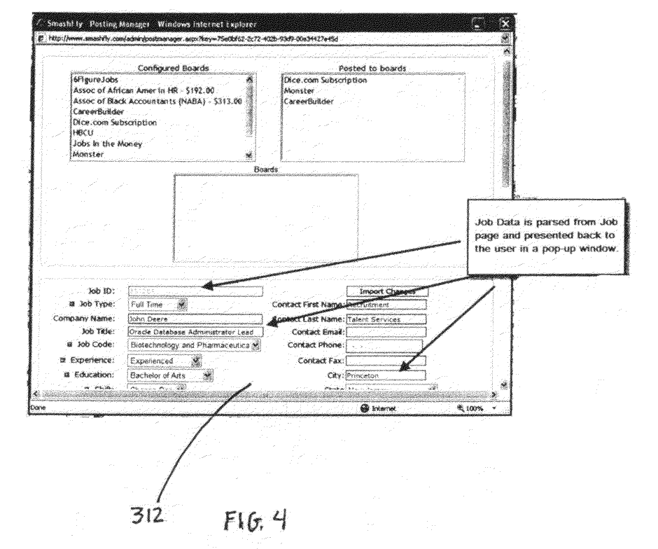

Once the transmission server 40 obtains the related data items, the transmission server 40 populates the data into a predetermined template or form and sends the template to the browser on the client computer 20. FIG. 4 shows one example of a predetermined template 312 that may be used to store data items related to a job posting. The data fields in the template 312 include Job ID, Job Type, Company Name, Job Title, etc. In one embodiment, the populated template 312 is returned to the client computer 20 in a new browser pop-up window. Next, in step 320, the user views the populated template 312 and selects the destination(s) and/or method(s) of transmission for the related data items in step 330. In one embodiment, the user 70 selects the destination(s) and/or method(s) of transmission from a predetermined list.

In step 340, the transmission server 40 receives the selected destination(s) and/or method(s) of transmission and transmits the related data items according to the selection(s). In one embodiment, prior to transmitting the related data items, the transmission server 40 accesses the format database 130. The transmission server 40 looks up the formats of the selected destination(s) and/or method(s) of transmission in the format database 130 and reformats the related data items into the corresponding stored formats. As described above, the destinations may be online posting boards, online communities, social networking sites, websites that post advertisements, email addresses or any other method for conveying information over the Internet.

In one embodiment, if the set of related data items does not contain all of the information required by a particular destination, the transmission server 40 will prompt the user 70 to supply the additional information.

In another embodiment of the invention, the transmission server 40 contacts the data server 30 on a regular basis and stores the unique identifiers and sets of related data items. In this embodiment, all of the unique identifiers and sets of related data items are stored on the transmission server 40 before the user 70 selects a specific unique identifier 151. For example, a company, on a nightly basis, may run a process by which they pull all the job data from specific companies' websites. In this embodiment, the user 70 selects the browser function 222 to pass the unique identifier 151 to the transmission server 40. Rather than contacting the data server as in steps 260, 270, 280, 290 and 300, the transmission server 40 already has the information and simply needs to look up the information related to the specific unique identifier 151 selected by the user 70. The data processing would then continue as describe above for steps 310, 320, 330 and 340.

As described above, one application for the present invention is marketing job opportunities. FIG. 5 shows an example of a job opportunity posted on a web site of a company. The set of related data items 500 for the job opportunity includes a job title 510, the location of the job 530 and a description of the job 520. All of these items are related data items as they relate to the same job opportunity. The job opportunity also includes a unique job identifier 540. The company having the job opportunity may want to advertise the opportunity through media other than its own website. However, each of the different media has a different predetermined format. By using an embodiment of the system 10 constructed according to the present invention, the company may achieve this goal.

Many companies use applicant tracking systems, also known as talent management systems, to track applicants for job openings. Examples of such systems include the Kenexa® and Taleo systems. FIG. 3 shows an example of a screenshot from a company using the Taleo system. The screenshot is of a web page 80 that includes a list of job opportunities 550. The list of list of job opportunities 550 includes a job identification field previously described as a list of unique identifiers 140. Each job opportunity is assigned a unique identifier 150. By selecting one of the job opportunities 550, the user will be shown the entire job listing as shown in FIG. 5.

In one embodiment, when utilizing the system 10 to distribute job opportunities, the client computer 20 is a computer utilized by a user 70 who is responsible for managing the job opportunity's placement. The client computer 20 is capable of executing a browser application. The data server 30 is a server that stores and generates web pages containing the information relating to the job opportunity. The transmission server 40 acts as a receiver for receiving a unique job identifier from the browser. The transmission server 40 also acts as a processor for (i) retrieving the plurality of job-related data items from the web page containing the unique job identifier and (ii) formatting the plurality of job-related data items into at least one of a plurality of predetermined formats. The transmission server 40 also acts as a transmitter for transmitting the plurality of job-related data items by the predetermined formats selected by the user 70. The transmission server 40 includes a web page database 120 that stores the format of how each web page stores the job-related information. The transmission server 40 also includes a format database 130 that stores the format of how the plurality of job-related data items must be sent to each of the destinations 50. The destinations 50 may be job posting boards, online communities such as the Facebook, LinkedIn and Twitter® communities, websites that post job-related information such as online newspapers, email addresses of potential applicants, or any method of reaching a potential job applicant. In the preferred embodiment, the communications link 60 is the Internet.

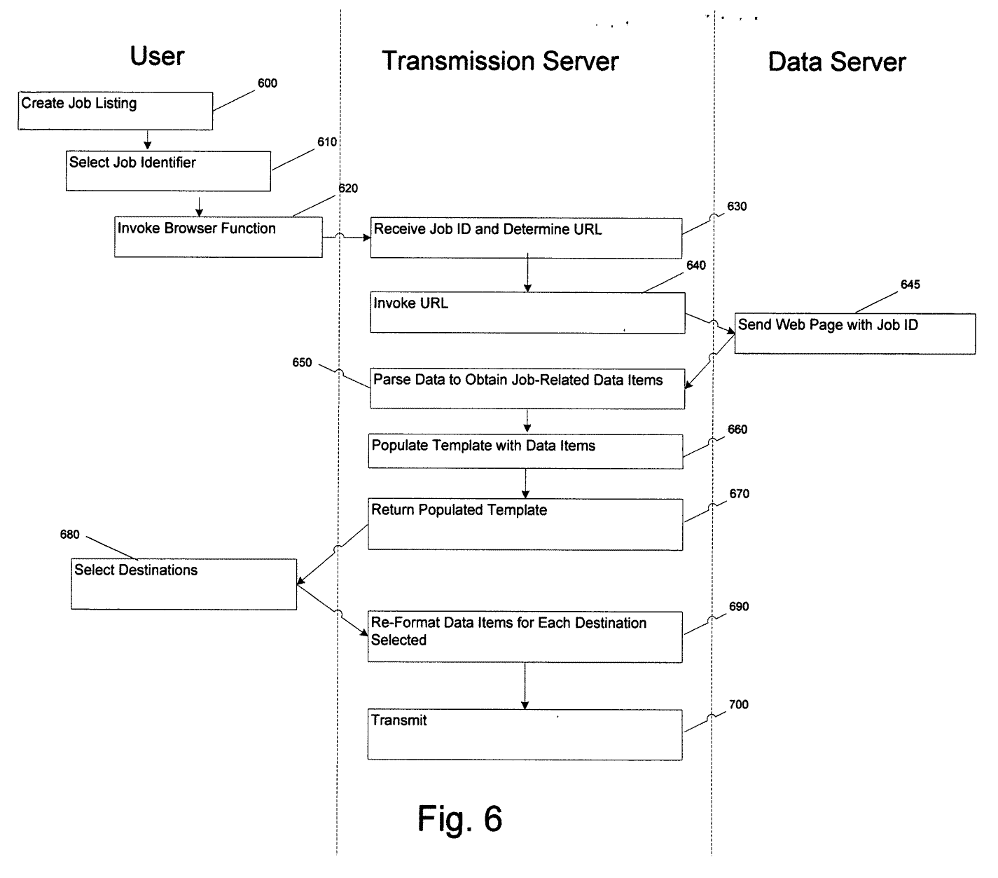

The operation of the system 10 when used for distributing job information through a plurality of different media is described with reference to FIG. 6. In step 600, an individual responsible for creating job postings creates the job opportunity listing through the applicant management software utilized by the company. Each job opportunity is assigned a unique job identifier. In step 610, the individual responsible for advertising the job opportunity through various media selects a particular job opportunity to be distributed. The job opportunity may be selected by one of the various methods described above in the discussion of FIG. 3. In one embodiment, the individual highlights the unique job identifier associated with the job opportunity. Next, in step 620, the individual invokes the browser function that is adapted for transmitting the unique job identifier to the transmission server 40. In one such embodiment, the individual selects the bookmarklet for the browser function. The browser function transmits the unique job identifier to the transmission server 40 via the communications link 60. In one embodiment, the message sent to the transmission server 40 contains the unique job identifier as one parameter along with other information.

In step 630, the transmission server 40 receives the message from the browser function and uses the information in the message to determine the URL of the web page containing the unique job identifier selected by the user 70. In one embodiment in which the user 70 pre-enrolls with the transmission server 70, the transmission server 70 uses the cookie stored on the client computer 20, which uniquely identifies the user 70 and the specific client, to determine the URL and lookup the appropriate format information. Next, the transmission server 40 invokes the URL to retrieve the web page from the data server 30 in step 640. Once the transmission server 40 receives the web page, it parses the HTML code to obtain the job-related data items that describe the corresponding job opportunity in step 650. In one embodiment, the transmission server 40 uses known techniques to parse the data. In another embodiment of the system 10, the transmission server 40 invokes a “Web service” API, which then allows the transmission server 40 to programmatically retrieve the job information from the data server 30.

In another embodiment, the transmission server 40 accesses a web page database 120 that stores the format of all the web pages that the transmission server 40 may need to parse. While parsing the data, the transmission server 40 will obtain such job-related data items as job title, job description, location, city, state, requirements, salary, benefits, etc.

Once the transmission server 40 has obtained the relevant job-related data items, the transmission server 40 populates a predetermined template with the data items in step 660. The predetermined template may also be referred to as a job posting web form. The transmission server then returns the job posting web form to the web browser as a new browser pop-up window in step 670.

Once the user 70 has reviewed the populated job posting web form, in step 680, the user 70 selects to which destinations the transmission server 40 will send the job-related data items. As described above, the user 70 may select job posting boards, online communities or social networking sites such as the Facebook, LinkedIn and Twitter sites, websites that post job-related information such as online newspapers, or email addresses of potential applicants. Next, in step 690, the transmission server 40 receives the destination selections from the user 70 and formats the job-related data items into the formats appropriate for each of the selected destinations. In one embodiment, the transmission server 40 accesses a format database 130 to determine the appropriate format for each of the selected destinations. In one embodiment, if the set of related data items does not contain all of the information required by a particular destination, the transmission server 40 will prompt the user 70 to supply the additional information. Finally, in step 700, the transmission server 40 transmits the properly formatted data to each of the selected destinations.

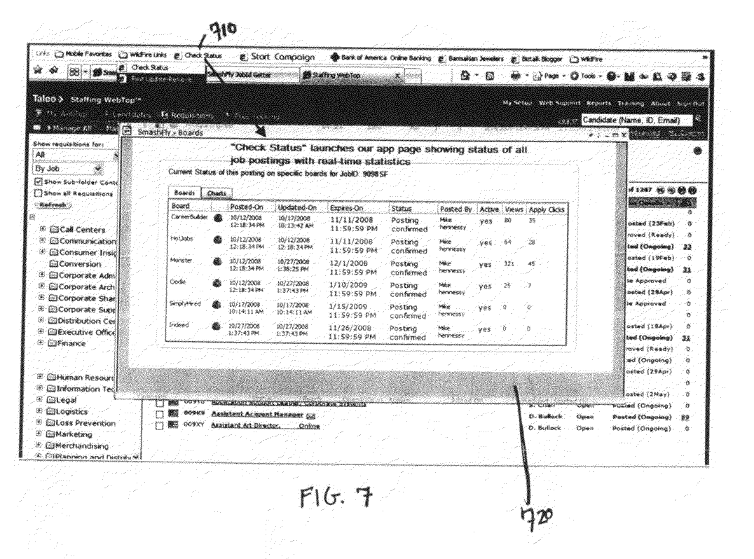

FIG. 7. shows a screen shot of one embodiment of the present invention in which the user 70 is able to check the status of all the job postings with real-time statistics. The user 70 may select the check status bookmarklet 710 and will receive a pop-up screen 720 that shows the status of all pending job postings.

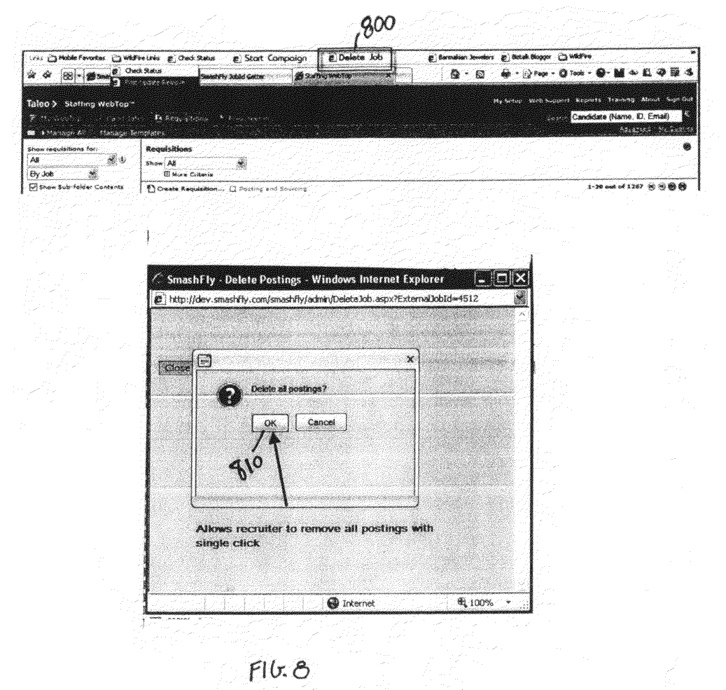

FIG. 8 shows a screen shot of one embodiment of the present invention in which the user 70 may delete all job postings from all destinations by selecting the delete job bookmarklet 800 and then selecting the “OK” button 810.

In order for a user 70 to make use of the system 10, the user 70 must first add the browser function to the web browser running on the client computer 20. To add the browser function, the user navigates to a set-up web page hosted by the transmission server 40. FIG. 9 shows a screen shot of an example web page that may be used to add browser functions to the browser running on the client computer 20. The browser functions to be added depend on the applicant tracking system and the browser being used. For example, if the Internet Explorer® 7 browser and the Taleo system are being used, the user 70 would select the browser functions under the heading “Internet Explorer 7—TALEO Links” 900. The browser functions to be added include: Post/Update/Remove 910, Check Status 920 and Delete Job 930. To add the browser function 910, the user 70 right clicks on the link for Post/Update/Remove 910 and selects the “Add to Favorites” option from the Internet Explorer 7 browser. The user repeats this process for the remaining browser functions 920 and 930. In one embodiment, once the browser functions are in the browser's favorites, the user 70 may add the browser functions 910, 920 and 930 to the browser toolbar by left clicking on the browser function and, while holding the left click, dragging the browser function to the toolbar.

Having described various embodiments of the invention, it will now become apparent to one of skill in the art that other embodiments incorporating the concepts may be used. It is felt, therefore, that these embodiments should not be limited to disclosed embodiments, but rather should be limited only by the spirit and scope of the following claims.

What is claimed is:

1. A method for transmitting a plurality of related data items by a plurality of predetermined formats, comprising:
receiving a unique identifier from a browser function, the unique identifier being assigned to a plurality of related data items;
retrieving the plurality of related data items from a web server storing the unique identifier;
formatting the plurality of related data items into at least one of a plurality of predetermined formats; and
transmitting the plurality of related data items by the at least one of the plurality of predetermined formats.

2. The method of claim 1, wherein the browser function is an applet stored as a URL of a bookmark in a browser.

3. The method of claim 2, wherein the browser function is a bookmarklet having the function of transmitting the unique identifier.

4. The method of claim 1, wherein the step of retrieving the plurality of related data items further includes retrieving the web page containing the unique identifier.

5. The method of claim 4, wherein the step of retrieving the web page further includes determining the configuration of the plurality of related data items on the web page.

6. The method of claim 1, wherein the step of formatting the plurality of related data items further includes populating the plurality of related data items into a predetermined template; and then reformatting the plurality of related data items from the predetermined template into at least one of a plurality of predetermined formats.

7. The method of claim 1, wherein the plurality of related data items is job information.

8. The method of claim 7, wherein the unique identifier is a job identifier.

9. The method of claim 8, wherein the at least one of a plurality of predetermined formats is a format of a job posting board and wherein the step of transmitting the plurality of related data items further comprises posting the job opportunity information to a job posting board.

10. The method of claim 8, wherein the at least one of a plurality of predetermined formats is a format of an online community and wherein the step of transmitting the plurality of related data items further comprises posting the job opportunity information to an online community.

11. The method of claim 8, wherein the at least one of a plurality of predetermined formats is a format of an email and wherein the step of transmitting the plurality of related data items further comprises sending the job opportunity information to plurality of recipients by an email campaign.

12. The method of claim 1, further comprising a user selecting the unique identifier from a plurality of unique identifiers and selecting the browser function.

13. The method of claim 1, wherein the browser function is an applet stored as a hyperlink on a web page.

14. A system for transmitting a plurality of related data items by a plurality of predetermined formats, comprising:
a receiver for receiving a unique identifier from a browser function, the unique identifier being assigned to a plurality of related data items;
a processor in communication with the receiver for (i) retrieving the plurality of related data items from a web page containing the unique identifier and (ii) formatting the plurality of related data items into at least one of a plurality of predetermined formats; and
a transmitter in communication with the processor for transmitting the plurality of related data items by the at least one of the plurality of predetermined formats.

15. The system of claim 14, further comprising a client computer with a browser having the browser function, wherein the browser function is adapted to transmit the unique identifier to the receiver.

16. The system of claim 15, wherein the browser function is a bookmarklet.

17. The system of claim 14, further comprising a web page database in communication with the processor, wherein the web page database stores a data structure for the web page containing the plurality of related data items.

18. The system of claim 14, further comprising a format database in communication with the processor, wherein the format database stores the plurality of predetermined formats.

19. The system of claim 14, wherein the plurality of related data items is job information.

20. The system of claim 14, wherein the unique identifier is a job identifier.

21. A method for transmitting a plurality of related data items by a plurality of predetermined formats, comprising:
assigning a unique identifier to a plurality of related data items;
selecting the unique identifier;
executing a browser function to transmit the unique identifier to a transmitter;
receiving at the transmitter the unique identifier from the browser function;
accessing a web page containing the unique identifier;
retrieving the plurality of related data items from the web page;
formatting the plurality of related data items into at least one of a plurality of predetermined formats; and
transmitting the plurality of related data items by the at least one of the plurality of predetermined formats.

22. A method for transmitting job information by a plurality of predetermined formats, comprising:
assigning a unique identifier to a job;
selecting the unique identifier;
executing a browser function to transmit the unique identifier to a transmitter;
receiving at the transmitter the unique identifier from the browser function;
accessing a web page containing the unique identifier;
retrieving the job information from the web page;
formatting the job information into at least one of a plurality of predetermined formats; and
transmitting the job information by the at least one of the plurality of predetermined formats.

23. A method for transmitting related data items by a plurality of predetermined formats, comprising:
storing a plurality of unique identifiers and corresponding related data items;
receiving one of the plurality of unique identifier from a browser function;
retrieving related data items corresponding to the received unique identifier;
formatting the related data items into at least one of a plurality of predetermined formats; and
transmitting the related data items by the at least one of the plurality of predetermined formats.
